(19) United States
(12) Patent Application Publication
(10) Pub. No.: US 2011/0215186 A1
(43) Pub. Date: Sep. 8, 2011

(54) WINDING DEVICE

(75) Inventors: ARMANDO VILAS BOAS, CHARVIEU-CHAVAGNEUX (FR); PIERRE COUTURIER, NANTOIN (FR)

(73) Assignee: ABB FRANCE, RUEIL-MALMAISON (FR)

(21) Appl. No.: 13/038,948

(22) Filed: Mar. 2, 2011

(30) Foreign Application Priority Data
Mar. 3, 2010 (FR) 10/51519

(51) Int. Cl. H01F 41/06

(52) U.S. Cl. 242/430

(57) ABSTRACT

The invention relates to a moving device for a coil core or a coil having a closed shape with an inner contour and an outer contour, including first and second rollers able to rotate around a respective axis and intended to bear against one of the two contours of the core or of the coil, means for driving at least one of said rollers in rotation, and retaining means associated with each roller, the retaining means being subject to first return means arranged to bring the first retaining means closer to the other of the two contours of the core or the coil, as well as a coil winder equipped with such a device.

### TECHNICAL FIELD

The present invention relates to a device for moving a coil core, or a coil having a closed shape with an inner contour and an outer contour, forward, and a coil winder equipped with such a device.

### BACKGROUND

Coil winders are used to make coils by winding a conductive wire, often made from copper and often electrically insulated by varnishing, around a ferromagnetic core, in particular made from soft iron.

The coil, due to the geometry of the core, is closed on itself, thereby delimiting a passage opening.

These coils can be applied by being included in the composition of Hall effect sensors.

The principle of these sensors lies in the current variation created by the passage of a metal bar inside the passage opening of the coil.

To that end, most of the time the coil of these sensors has a toroidal shape so as to allow the passage, in the opening thereof, of a round bar or a rectangular bar depending on the product families.

However, for specific needs related to the bulk, it is necessary to miniaturize these sensors. Indeed, having a round bar passage affects the bulk of the sensor, which is a constraint for integrating sensors into increasingly compact systems.

This miniaturization requires changing the toroidal shape of the coil of the sensor and therefore requires a coil winder capable of winding a conductive wire around a core having a non-toroidal shape.

A coil winder used to wind a toroidal core comprises three rollers arranged around the core of the coil and coming into contact therewith.

At least one of these three rollers is a driving roller and drives the core in rotation at a constant speed in order to allow a shuttle passing through the passage opening of the core to practically uniformly wind the conductive wire around the section of the core.

This moving device is satisfactory for making coils with toroidal shapes, but is not intended to receive a core having another shape, in particular an oblong shape.

Starting from existing elements of this moving device, first adaptations were done to try to perform winding on an oblong core.

This adaptation consists of fixing the core, flat, along its primary plane, on an open plastic shim at the opening thereof in order to allow the passage of the shuttle.

The shim is then placed between the three rollers, the spacing of which has been modified and moved in translation by at least one of them.

However, the method for adapting the existing tool is tedious to carry out and has the major drawbacks of only being able to perform partial winding on the two lengths of the oblong core and causing an imbalance between these two wound parts.

Document DE10146169A1 provides a solution for performing winding on a core having a non-toroidal shape, and in particular an oblong shape.

This solution consists of using a belt to drive the core or coil in rotation.

The belt is stretched by a set of rollers arranged carefully so that it partially grasps the core or the coil on its outer contour.

However, this causes a modification of the position of the rollers or the use of a belt with a different length to wind cores with different sizes.

Moreover, by using a belt, the rotational movement of the core created by the belt does not keep a constant distance between the shuttle and the core or the coil, which can cause distensions of the wire over certain portions of the coil, in particular on the curved portions of the core.

As a result, the choice of this solution causes significant excess costs related to the purchase of this type of coil winder with a set of belts having different lengths and the preventive or curative maintenance thereof, in particular by replacing belts.

### BRIEF SUMMARY

The present invention aims to resolve all or some of the aforementioned drawbacks.

To that end, the present invention relates to a moving device for a coil core or a coil having a closed shape with an inner contour and an outer contour, characterized in that it includes first and second rollers able to rotate around a respective axis and intended to bear against one of the two contours of the core or of the coil, means for driving at least one of said rollers in rotation, first retaining means associated with the first roller, the first retaining means being subject to first return means arranged to bring the first retaining means closer to the other of the two contours of the core or the coil, and second retaining means associated with the second roller, the second retaining means being subject to second return means arranged to bring the second retaining means closer to the other of the two contours of the core or of the coil.

These arrangements make it possible to wind a core or a coil with non-toroidal shapes, in particular oblong shapes, while also making it possible to wind toroidal shapes.

This device also grants the core or the coil a revolution movement keeping the shuttle at a substantially constant distance from the coil or the core, thereby reducing the risks of distension of the wire on the core or the coil.

According to one embodiment, the retaining means are able to rotate around the axis of rotation of their respective roller.

According to the same embodiment, the device comprises two arms associated with each roller and each comprising a body on which the retaining means and the return means are arranged, said arms including means allowing the rotation of the retaining means around the axis of their respective rollers.

According to one embodiment, the retaining means can move in translation along an axis cutting the axis of rotation of their respective roller.

According to the same embodiment, the device comprises two arms associated with each roller and each comprising a body on which the retaining means and the return means are arranged, said arms including means allowing the translation of the retaining means along an axis cutting the axis of rotation of their respective roller.

According to one embodiment, at least one of the arms includes a guide means.

This arrangement makes it possible to maintain an arm so as to prevent it from going askew and hindering the emptying of the wire from the shuttle during the movement of the core or the coil.

According to the same embodiment, the two arms each include a means for adjusting the return means.

This arrangement makes it possible to adjust the stiffness of the return means as a function of the thickness of the section of the core, but also as a function of the number of overlaps and turns of the coil to be made.

According to the same embodiment, the body has a surface intended to ensure sliding contact of the first roller 4a or the second roller 4b.

According to one embodiment, the device comprises a support shim arranged on a fixed support and intended to ensure sliding contact of the core or the coil.

This arrangement makes it possible to maintain the movement of the core or of the coil along a same plane perpendicular to the axis of rotation of the driving rollers.

According to one embodiment, the driving means ensuring the rotational movement of at least one roller include a Cardan joint.

The use of a Cardan joint eliminates, in the rotational driving movement of the driving roller, the lateral play that may be caused by a transmission by simple interlocking due to shape complementarity.

According to one embodiment, the driving means include a system for adjusting the play.

This arrangement makes it possible to eliminate the longitudinal play of the transmission that may be caused during rotation thereof and thus prevents a break in the transmission, which would result in winding several turns in the same location of the core or coil.

According to the same embodiment, the system for adjusting the play includes at least one spring.

The spring makes it possible to design an efficient adjustment system with a lower cost.

According to one embodiment, a shim is used to raise the driving means in order to facilitate the movement thereof.

This arrangement provides additional support to the driving means.

The present invention also relates to a coil winder equipped with a moving device according to the invention.

### BRIEF DESCRIPTION OF THE DRAWINGS

Other features and advantages of the invention will emerge from the detailed description below, considered in connection with the drawings, which illustrate, as an example, the principles of the invention.

FIG. 1 illustrates the operation of a coil winder for a core or coil having a toroidal shape.

FIG. 2 illustrates the operation of a coil winder equipped with a moving device according to the invention.

FIG. 3 shows a top view of an arm used in the moving device according to the invention.

FIG. 4 shows a bottom view of an arm used in the moving device according to the invention.

FIG. 5 shows driving means used in the moving device according to the invention.

FIG. 6 shows an exploded view of the driving means illustrated in FIG. 5.

FIG. 7 shows an exploded view of a roller mounted on an arm.

FIG. 8 shows the actuating portion driving the driving means.

FIG. 9 shows a lateral view of an arm as well as driving means on which a driving roller is mounted.

FIG. 10 is a top view of a support for an arm and a driving roller in a moving device according to the invention.

FIG. 11 is a front view of a coil winder equipped with a moving device according to the invention.

FIG. 12 shows a partial top view illustrating the operation of the arms according to the invention in a situation with a coil.

FIG. 13 shows a partial side view illustrating the operation of the arms according to the invention in a situation with a coil.

### DETAILED DESCRIPTION

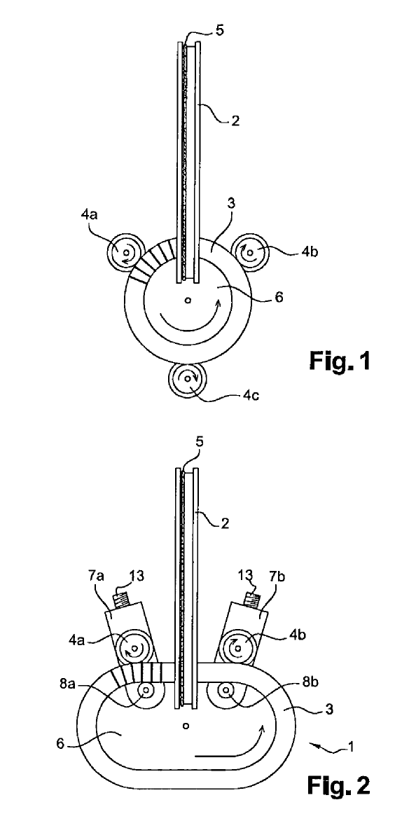

As illustrated in FIG. 1, a coil winder originally used to wind a core 3 or a coil 3′ with a toroidal shape and subsequently adapted to receive a moving device 1 according to the invention, comprises a shuttle 2 passing through a passage opening 6 of the core or coil 3′ and delivering a copper wire 5 to be wound around the core or the coil 3′ as well as three driving rollers 4a, 4b and 4c.

In the continuation of the description, the terms core 3 and coil 3′ may be used interchangeably to designate the piece on which the winding is done, the core 3 becoming a coil 3′ at the end of a first covering layer by the copper wire 5.

The three driving rollers 4a, 4b and 4c have a gripping surface placed in contact with the outer contour of the core 3 or the coil 3′ in order to drive the latter in rotation.

The driving rollers 4a and 4b are arranged on either side of the shuttle 2, while the third driving roller 4c is arranged facing the shuttle 2.

In order to drive the core 3 or the coil 3′ in rotation, only one of the three rollers needs to be a driver, the other two then being mounted freely rotating and serving only as a guide for the core 3 or the coil 3′.

The shuttle 5 rotates at a constant speed at the same time as the three driving rollers 4a, 4b and 4c in order to position the turns of a same covering layer series regularly next to each other.

As illustrated now in FIG. 2, a moving device of a coil 3′ core 3 or of a coil 3′ according to the invention only comprises the driving rollers 4a and 4b arranged on either side of the shuttle 2.

With the third driving roller 4c, it is obvious that a core 3 or a coil 3′ with an oblong shape, like that illustrated in FIG. 2, could not be made to rotate due to the difference in the distance between the points of contact of the three rollers during rotation of the core 3 or of the coil 3′.

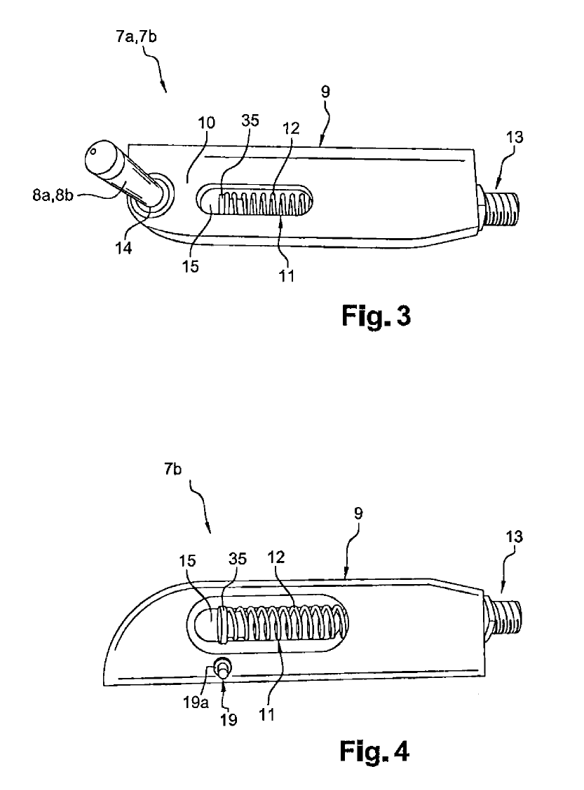

In the moving device 1 according to the invention, the third roller 4c has been replaced by two arms 7a and 7b illustrated in detail in FIGS. 3 and 4.

According to a first preferred embodiment, each arm 7a, 7b is arranged horizontally and made up of a body 9 having an oblong shape as well as a sliding contact surface 10 of the first roller 4a or the second roller 4b. To that end, a flat washer 33, visible in FIG. 7, is inserted between the sliding contact surface 10 and each of the rollers 4a, 4b.

Each of the rollers 4a, 4b includes a circumferential shoulder 30.

Each of these arms 7a, 7b also comprises an oblong through opening 11 formed by milling in the direction of the length of the body 9 of the arm 7a, 7b also with a substantially oblong shape.

Inside said opening 11, a return means 12 is placed materialized by a compression spring 12 bearing on one of its ends on an adjustment means 13 materialized in the form of an adjustable bolt passing through the body 9 and maintained by a nut.

The length of the spring 12 and the adjustment of the adjusting means 13 reveal a passage 15 in the opening 11. This passage 15 is intended for the insertion of an axis 17 of a driving roller 4a, 4b. The action of the spring 12 maintains the arm 7a, 7b on the axis of the roller 4a, 4b in a plane substantially perpendicular thereto.

To help this maintenance, the spring 12 can include a Teflon sleeve 35 partially inserted in the spring 12 and increasing the contact surface with the axis 17 of a driving roller 4a, 4b. This sleeve 35 also serves as wearing ring and improves the sliding of the axis 17 of a driving roller 4a, 4b through the use of a Teflon metal contact.

Each arm 7a, 7b also comprises a retaining means 8a, 8b extending transversely to the sliding contact surface 10 of the body 9 of the arm 7a, 7b and mounted freely rotating on a bearing 14 incorporated into the body 9.

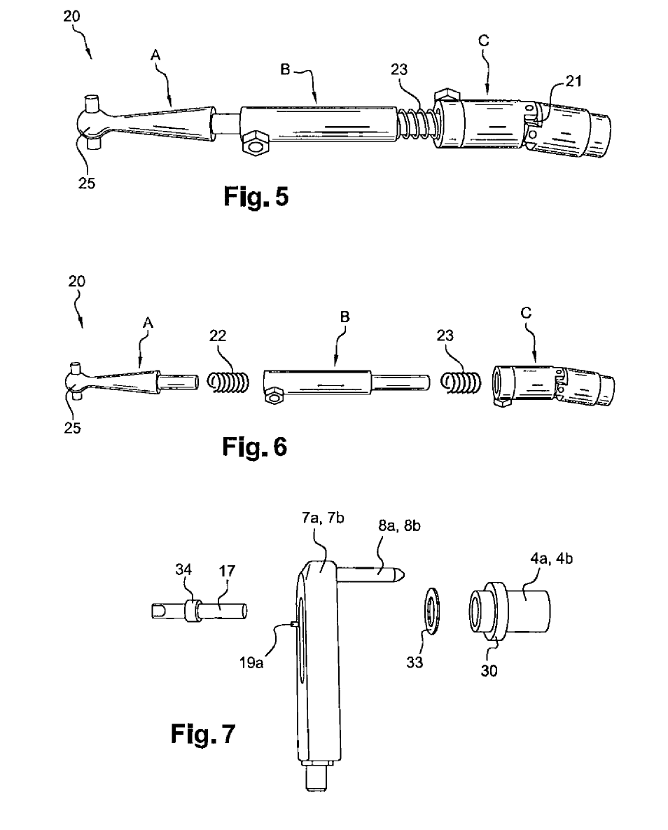

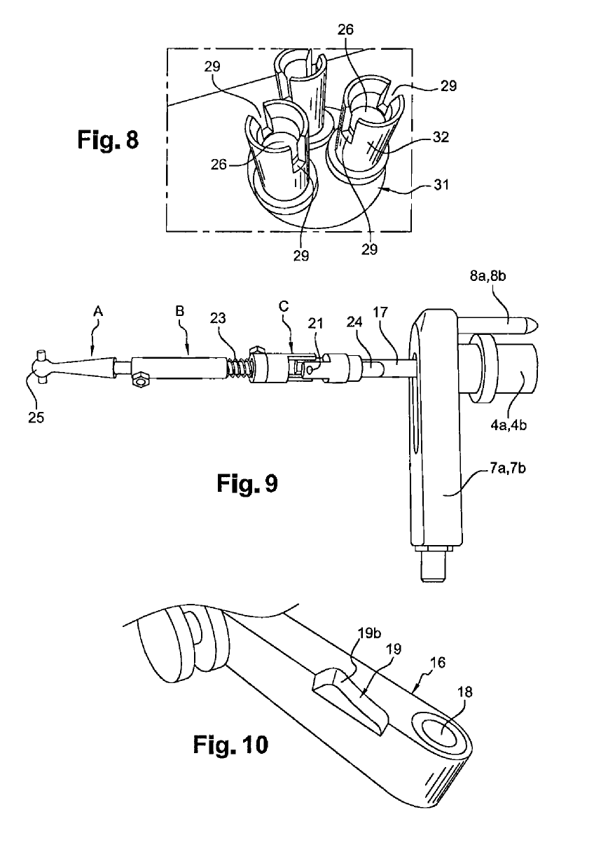

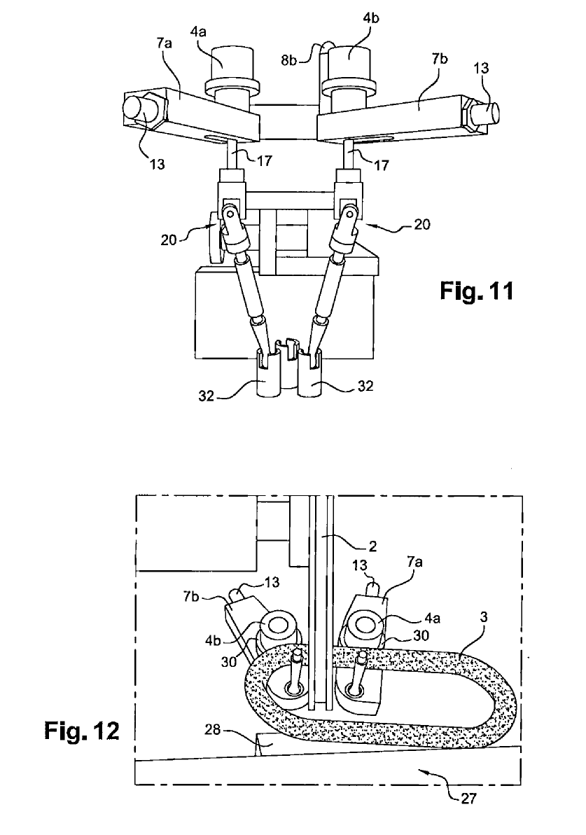

At least one of the rollers 4a, 4b is driven in rotation by driving means 20. Driving means 20 are illustrated in FIG. 5.

Driving means 20 comprise three portions A, B, and C interlocking and sliding in each other.

A first end of the portion A slides in the portion B and is kept at a distance therefrom by the action of a first compression spring 22 bearing on one hand on one end of the portion A and on the other hand on the bottom of a cavity formed in the portion B to guide the translation of that same end of the portion A.

The portion B slides in the portion C and is kept at a distance therefrom by the action of a second compression spring 23 bearing on one hand on an annular shoulder at the base of one end of the portion B, and on the other hand on the bottom of a cavity formed in a first end of the portion C to guide the translation of that same end of the portion B.

The portion C comprises a Cardan joint articulation 21 as well as a second cavity formed at its second end in which the axis 17 of a roller 4a or 4b is inserted.

Each connection formed by one end of the portions A, B, C as well as the end 24 of the axis 17 of a driving roller 4a, 4b as well as by the different cavities formed in these different parts is ensured using devices with complementary shapes ensuring the blocking of the rotation between two adjacent portions and allowing the translation by sliding between two adjacent portions.

These devices can indifferently be formed by flat sections, grooves, keys, or any other device known by those skilled in the art blocking the rotation without blocking the translation between two adjacent portions. It is also possible to consider only leaving one of the connections between two adjacent portions free in translation, in which case the other connections may be blocked in translation and in rotation by devices known by those skilled in the art, such as screws on nuts or pins. Translational and rotational blocking of the set of connections is also possible.

The second end 25 of the portion A comprises a spherical head with two branches extending transversely from said spherical head. Thus, the head and its two branches form a T-shaped end 25.

This T-shaped end 25 is intended to be inserted into one of the three actuating cylinders 32 of the actuating portion 31 of the coil winder.

By using a single actuator and a set of gears (not shown), the three actuating cylinders 32 rotate together at the same speed of rotation.

To that end, each of the three actuating cylinders 32 comprises two notches 29 diametrically opposite each other and open on the top of the actuating cylinders 32 to be able to receive the branches of the “T” there formed on the end 25 of the portion A.

The spherical head of the end 25 bears in the bottom of the actuating cylinders 32. Teflon shims 26 are arranged in that same bottom in order to raise the driving means 20. These shims 26 also serve as wearing shims through the use of a Teflon metal contact.

Thus, a kinematic chain is made formed by an actuator, the three actuating cylinders 32, the driving means 20, and the driving rollers 4a, 4b.

As illustrated in FIG. 7, the axis 17 of a driving roller 4a, 4b comprises a circumferential shoulder 34 maintained in the passage 15 formed between the return means 12 and the body 9 of the arm 7a, 7b. Each of the assemblies formed by a roller 4a or 4b with its axis 17 is then engaged in a passage 18 formed in the support 16, which simultaneously supports the arms 7a, 7b, the driving means 20, and a driving roller 4a, 4b. The diameter of the circumferential shoulder 34 is very slightly smaller than the width of the oblong opening 11 in order to maximally decrease the play between the arms 7a, 7b and the axis 17 of each of the rollers 4a, 4b.

As illustrated in FIG. 10, the support 16 comprises guide means 19 whereof a first portion is made up of a cylindrical element 19a protruding transversely from the face of the arm 7a, 7b coming against the support 16 and a second portion 19b is machined on the outer upper edge of the support near the passage 18.

These guide means 19 make it possible to limit the rotational and translational travel of the body 9 of the arm 7a, 7b during winding, and thereby prevent the body 9 from being in the recess area of the wire 5 of the shuttle 2.

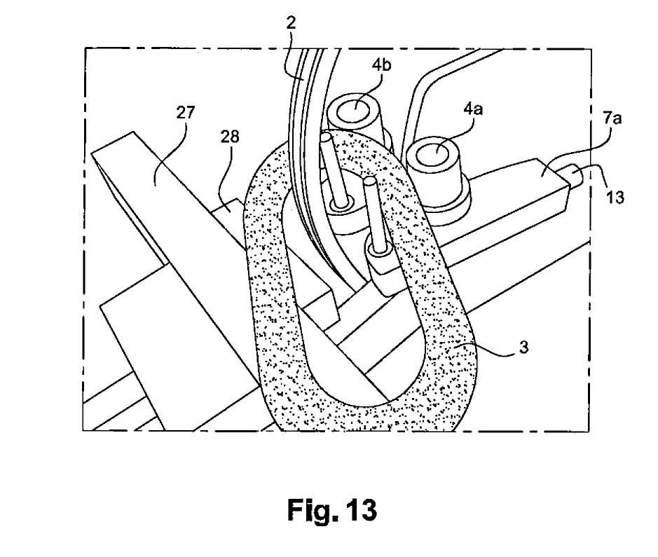

Lastly, as shown in particular by FIGS. 12 and 13, a support shim 27 is arranged opposite the shuttle 2 in order to support the core 3 or the coil 3′ during revolution movement thereof. This support shim 27 comprises a retractable portion 28 so that it can adapt to cores 3 or coils 3′ with different heights.

During the use of a coil winder equipped with a moving device 1 of a coil 3′ core 3 or of a coil 3′, the operator starts by introducing the core 3 into the shuttle 2 through its passage opening 6.

Then the operator places the core 3 or the coil 3′ flat on the shoulder 30 of the two rollers 4a, 4b, between those same rollers 4a, 4b and the retaining means 8a, 8b as well as on the support shim 27 with or without the retractable portion 28 depending on the size of the core 3 or the coil 3′ to be wound.

The retaining means 8a, 8b of each arm 7a, 7b continuously maintain a section of the core 3 or the coil 3′ respectively against the driving roller 4a or 4b through action of the return means 12. To that end, the stiffness of the spring 12 can be adjusted by maneuvering the adjustment means 13.

The action of the return spring 12 simultaneously increases at the thickness of the section of the coil 3′ in the maintenance zones of the arms 7a and 7b due to the overlap of several turns of the coil 3′.

The retaining means 8a, 8b are free in rotation on their bearing 14 with the result that when the shuttle 2 and the actuating portion 31 are started at the same time, the driving means 20 transmit a rotational movement to the driving rollers 4a and 4b, which in turn drive the core 3 or the coil 3′ in a planar revolution movement.

This movement keeps the core 3 or the coil 3′ at a substantially constant distance from the shuttle 2.

At the same time as this planar revolution movement, the coil winder winds the copper wire 5 around the section of the core 3 or of the coil 3′ located in the axis of the shuttle 2, which results in uniformly distributing the turns on the core 3 or the coil 3′.

During its revolution movement, the core 3 or the coil 3′ can drive a slight rotational movement of the arms 7a or 7b around the axis of the driving rollers 4a, 4b on which they are mounted.

This slight rotational movement in turn drives a slight translational movement of the arms 7a, 7b and therefore of the retaining means 8a, 8b along the main axis of the oblong opening 11.

Indeed, if initially the points of contact of a driving roller 4a or 4b and their respective retaining means 8a or 8b are aligned along a straight section of the core 3 or of the coil 3′ corresponding to their minimum deviation, the rotation of an arm 7a or 7b modifies this alignment and therefore the distance between a driving roller 4a or 4b and its respective retaining means 8a or 8b.

The rotation of an arm 7a or 7b can be counterbalanced by the action of the operator, who brings the arm 7a or 7b back into alignment with the straight section of the core 3 or of the coil 3′.

Although the invention has been described in connection with specific embodiments, it is obviously in no way limited thereto and encompasses all technical equivalents of the means described as well as combinations thereof if they are within the scope of the invention.

1. A moving device for a coil core or a coil having a closed shape with an inner contour and an outer contour, comprising:
first and second rollers able to rotate around a respective axis and intended to bear against one of the two contours of the core or of the coil,
means for driving at least one of said rollers in rotation,
first retaining means associated with the first roller, the first retaining means being subject to first return means arranged to bring the first retaining means closer to the other of the two contours of the core or the coil, and
second retaining means associated with the second roller, the second retaining means being subject to second return means arranged to bring the second retaining means closer to the other of the two contours of the core or of the coil.

2. The moving device according to claim 1, wherein the retaining means are able to rotate around the axis of rotation of their respective roller.

3. The moving device according to claim 2 including two arms associated with each roller and each comprising a body on which the retaining means and the return means are arranged, said arms including means allowing rotation of the retaining means around the axis of their respective rollers.

4. The moving device according to claim 1, wherein the retaining means can move in translation along an axis cutting the axis of rotation of their respective roller.

5. The moving device according to claim 4, including two arms associated with each roller and each comprising a body on which the retaining means and the return means are arranged, said arms including means allowing the translation of the retaining means along an axis cutting the axis of rotation of their respective roller.

6. The moving device according to claim 5, wherein at least one of the arms includes a guide means.

7. The moving device according to claim 5, wherein the two arms each include a means for adjusting the return means.

8. The moving device according to claim 3, wherein the body has a surface intended to ensure sliding contact of the first roller or the second roller.

9. The moving device according to claim 1, including a support shim arranged on a fixed support and intended to ensure sliding contact of the core or the coil.

10. The moving device according to claim 1, wherein the driving means ensuring the rotational movement of at least one roller include a Cardan joint.

11. The moving device according to claim 1, wherein the driving means include a system for adjusting the play.

12. The moving device according to claim 11, wherein the system for adjusting the play includes at least one spring.

13. The moving device according to claim 1, wherein a shim is used to raise the driving means in order to facilitate the movement thereof.

14. A coil winder including a moving device according to claim 1.
